(19) United States
(12) Patent Application Publication
(10) Pub. No.: US 2005/0082842 A1
(43) Pub. Date: Apr. 21, 2005

(54) Vehicle door lock

(76) Inventors: Werner Warmke, Mulheim (DE); Bernd Kluting, Radevormwald (DE); Frank Horschgen, Solingen (DE)

Correspondence Address: Martin A Farber, 866 United Nations Plaza, Suite 473, New York, NY, 10017, US

(21) Appl. No.: 10/495,520

(22) PCT Filed: Nov. 22, 2002
(86) PCT No.: PCT/EP02/13163

(30) Foreign Application Priority Data
Nov. 23, 2001 (DE) 101 57 597.1

(51) Int. Cl. E05C 3/06

(52) U.S. Cl. 292/216

(57) ABSTRACT

Motor-vehicle door lock (1) which can be actuated by means of an interior handle and an exterior handle, wherein the exterior handle acts on a trigger (15), actuation of which triggers a catch (9) to retain a rotary latch (10) in an unlocked position of the lock, and is inactive in a locked position and in a safeguarding position. The interior handle (30) acts on a transmission lever (14) which triggers the catch (9) in the unlocked position and the locked position, and is inactive in the safeguarding position. The transmission lever (14) has a switching member (26) wherein in the locked position, initial actuation of the interior handle (30) switches over the switching member (26) from the inoperative position into the operative position, and switches over the lock (1) into the unlocked position.

The invention relates to a motor-vehicle door lock which can be actuated by means of an interior handle and an exterior handle, it being the case that the exterior handle acts on a trigger, actuation of which triggers a catch, which retains a rotary latch, in an unlocked position of the lock and is inactive in a locked position and in a safeguarding position, and that the interior handle acts on a transmission lever, actuation of which triggers the catch in the unlocked position and in the locked position and is inactive in the safeguarding position.

Such a motor-vehicle door lock is known from DE 198 53 160 A1, it being possible, once the motor-vehicle door has been closed and locked, for the safeguarding position to be brought about by means of an actuating member, so that unlocking by means of the interior handle is not possible.

It is an object of the invention for the construction of a motor-vehicle door lock of the generic type to be simplified and rendered more advantageous in control terms.

This object is achieved first and foremost in the case of a motor-vehicle door lock having the features of Claim 1, this being based on the fact that the transmission lever has a switching member which, in the unlocked position, assumes an operative position, which allows transmission of movement to the catch, and, in the locked position and in the safeguarding position, assumes an inoperative position, which renders the transmission lever inactive, it being the case that, in the locked position, initial actuation of the interior handle switches over the switching member from the inoperative position into the operative position and switches over the lock into the unlocked position.

The subject matters of the rest of the claims are explained hereinbelow with reference to the subject matter of Claim 1, but may also be important in respect of their independent wording.

Such a configuration provides a motor-vehicle door lock of the type in question which is distinguished by a structurally advantageous configuration. The components for the motor-vehicle door lock are limited to a minimum. There are also control-related advantages. When the motor vehicle is left, the lock can be moved into a safeguarding position, for example, via key-controlled radio actuation. This safeguarding position is such that both the trigger, which is associated with the exterior handle, and the transmission lever, which is associated with the interior handle, are inactive. This is because, when the safeguarding position is brought about, the switching member of the transmission lever passes into the inoperative position, so that, upon actuation of the interior handle, the transmission lever is indeed pivoted, but the catch, which secures the rotary latch, is not triggered. It is, however, possible, if for example someone is left behind in the motor vehicle, to activate exclusively the locked position of the lock. It is also the case here that the switching member still remains in an inoperative position, which renders the transmission lever inactive. This inoperative position is such that initial actuation of the interior handle by the person remaining in the motor vehicle switches over the switching member from this inoperative position into the operative position. At the same time, the lock is also changed over into the unlocked position. It is thus possible for the lock to be opened both by the exterior handle and, upon the second actuation, by the interior handle as well. The procedure here, in a straightforward manner in production terms, is such that the trigger is articulated in a rotatable manner on a safeguarding lever which can be pivoted, by means of a first actuating motor, between a position which is associated with the unlocked position of the lock and a position which is associated with the locked position of the lock. The safeguarding lever can thus be moved into two positions by means of the first actuating motor. If this position is the one which is associated with the unlocked position of the lock, then the trigger, which is controlled by the exterior handle, is inactive. It is only in the other position, which is associated with the unlocked position of the lock, that the trigger causes the locked position of the catch in relation to the rotary latch to be eliminated. Moreover, it is possible for the trigger already to be actuated and, for example, retained prior to the safeguarding lever being displaced out of the position which is associated with the unlocked position of the lock. The catch is then triggered when the safeguarding lever is driven back, by means of the first actuating motor, into the position which is associated with the unlocked position of the lock. Incorrect actuation of the lock is thus reduced to a minimum. Furthermore, it is an advantageous feature of the invention that the switching member is formed as a lever, in particular angled lever, which is disposed at the end of the two-armed transmission lever, has a control member, which is driven by a second actuating motor, acting on one arm and has its second arm acting, in particular via a lever, on the catch. Via this second actuating motor, the switching member can be transferred into the inoperative position by means of the control member. The resulting safeguarding position can be brought about, for example, via the key-based radio control or also, during travel, in a speed-dependent manner. Also noteworthy is the fact that a control protrusion formed by the second arm, in the operative position, acts on the lever upon actuation of the interior handle, and a control cam, which is formed by the first arm of the switching member, with the control member disengaged in the inoperative position, acts on the safeguarding lever upon initial actuation of the interior handle in order to pivot the safeguarding lever into the position which is associated with the unlocked position and, with the control member held in engagement, in order to move the control cam past the safeguarding lever upon actuation of the interior handle. The switching member may thus be controlled such that, on the one hand, it interacts with the safeguarding lever and, on the other hand, following actuation of the control member, it can move past the safeguarding lever. In order to realize this in a straightforward manner, the control cam slides along a control rib of the safeguarding lever in the pivoted-back position of the control member, which is formed as a lever, and, with the control member pivoted forward, a drive protrusion of the switching member slides along a control curve of the same. In order for it to be possible to carry out key-dependent opening of the lock in the safeguarding position and with the control member pivoted and the switching member moved into the inoperative position, the second actuating member acts on the control member by way of a non-blocking worm drive. Return displacement of the same is thus possible. Furthermore, it is also possible for the lock to be used for rear motor-vehicle doors and to be provided with childproof locking there. The lock is then additionally distinguished by a childproof-locking position, in which, starting from the locked position, the lock can be displaced into the unlocked position by initial actuation of the interior handle, but second actuation of the interior handle is inactive. In order for it to be possible to realize this in a straightforward manner, in the childproof-locking position, the second arm of the switching member is moved past the lever and/or the catch upon actuation of the interior handle. Finally, in order to achieve a disruption-free locking function, it is also provided that the first actuating motor acts on the safeguarding lever by way of a worm drive which, in its two end positions, allows the safeguarding lever to be pivoted freely, the safeguarding lever being forced by torques in the direction of the respective end position upon trigger actuation. The free pivoting action of the safeguarding lever can be produced, for example, by a corresponding radial-slot arrangement of the driving worm, the slot width corresponding approximately to the thickness of the safeguarding lever in order that, in a corresponding rotary position of the worm, the safeguarding lever can pivot through.

A schematically illustrated exemplary embodiment of the invention is explained hereinbelow with reference to the drawings, in which:

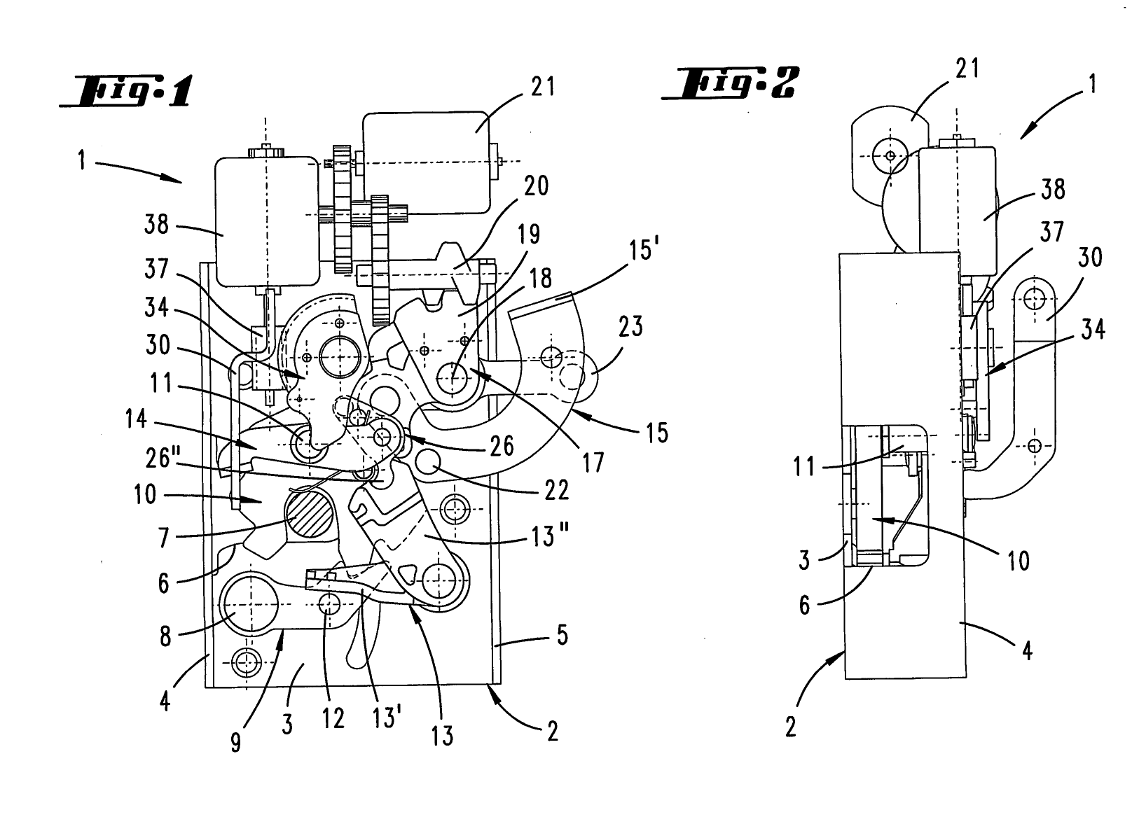

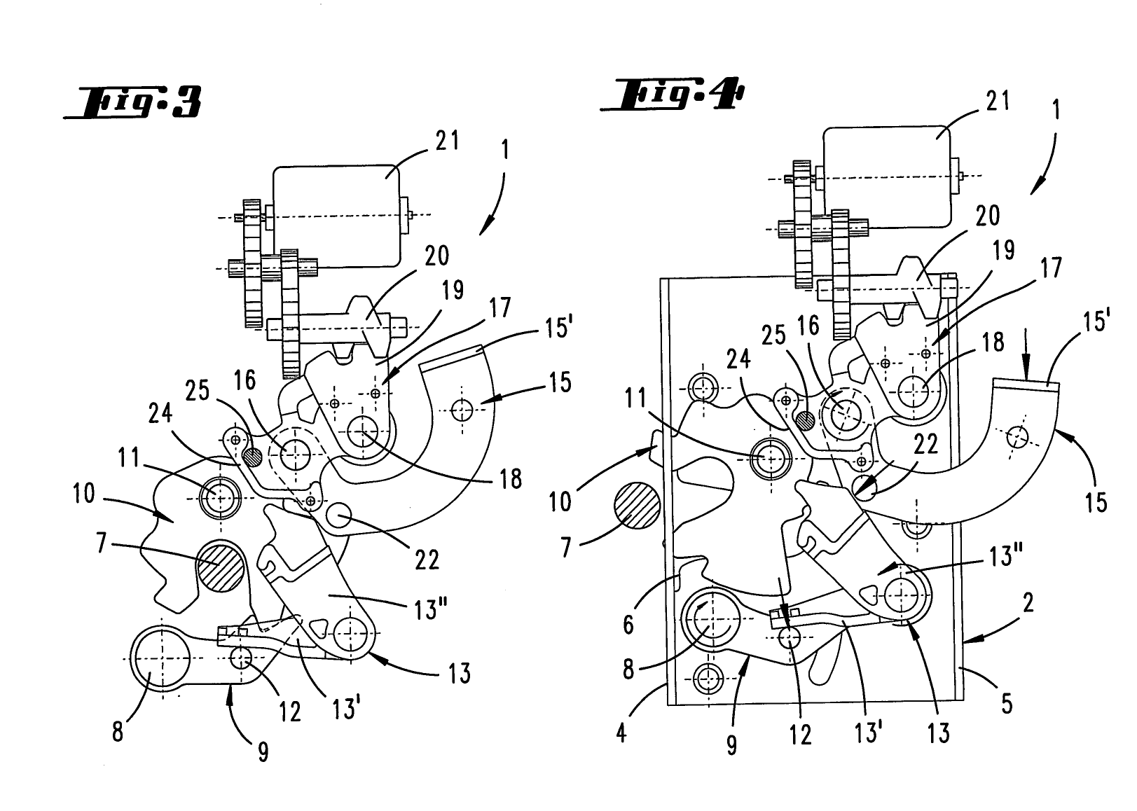

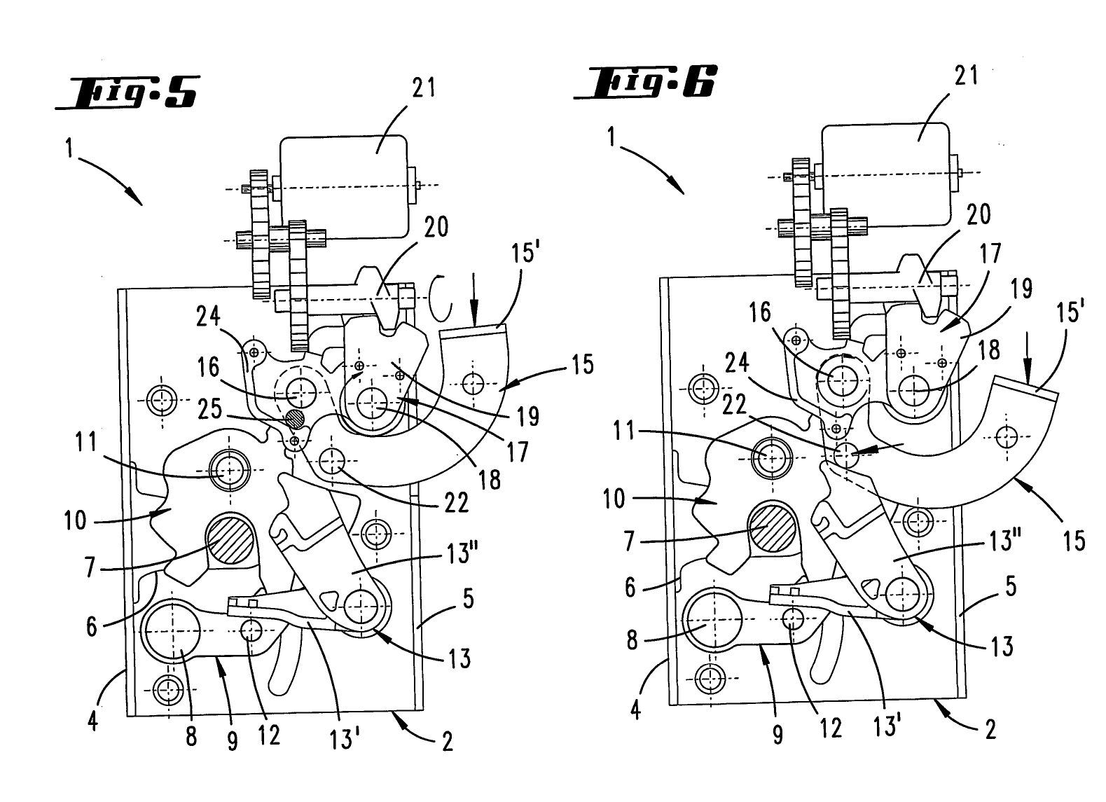

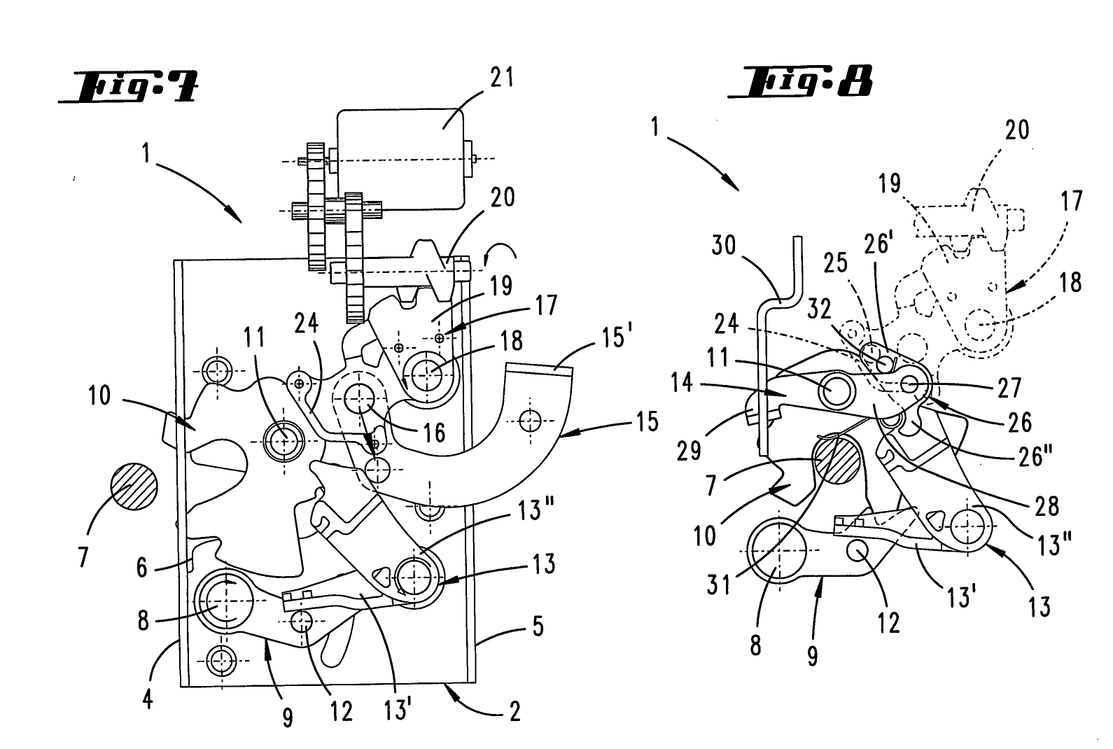

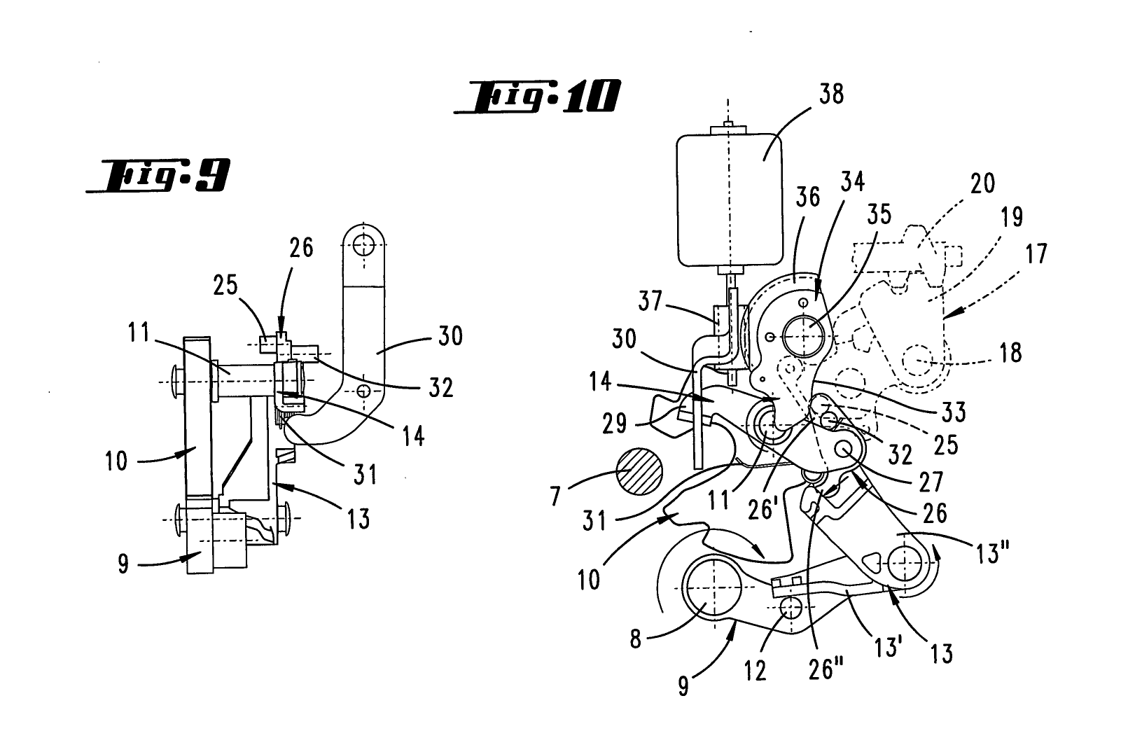

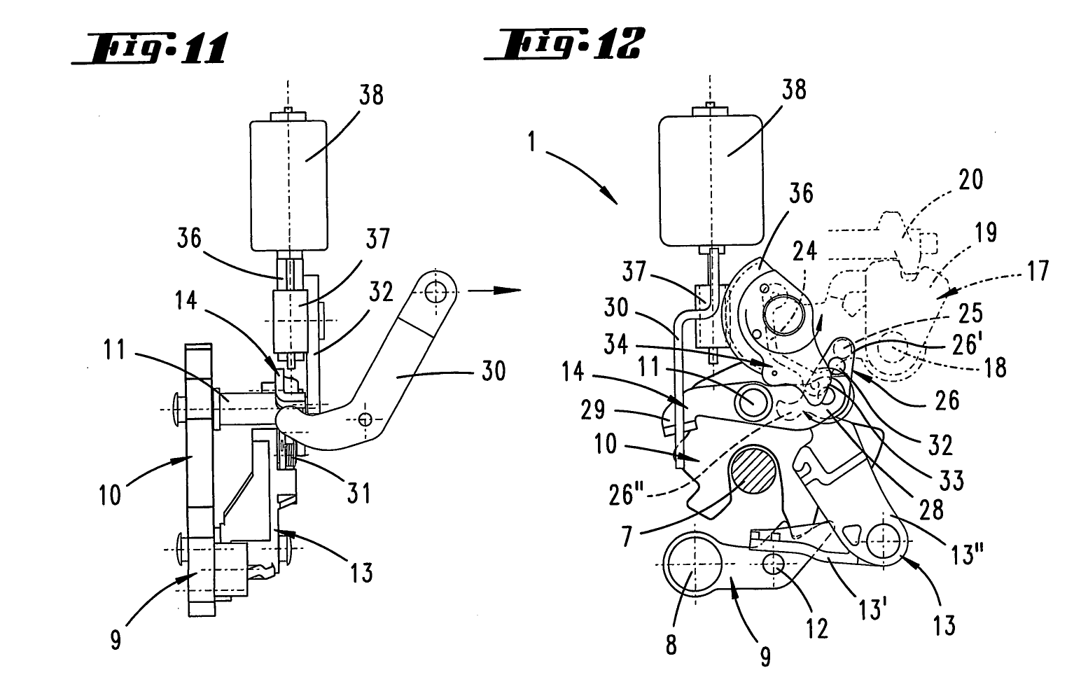

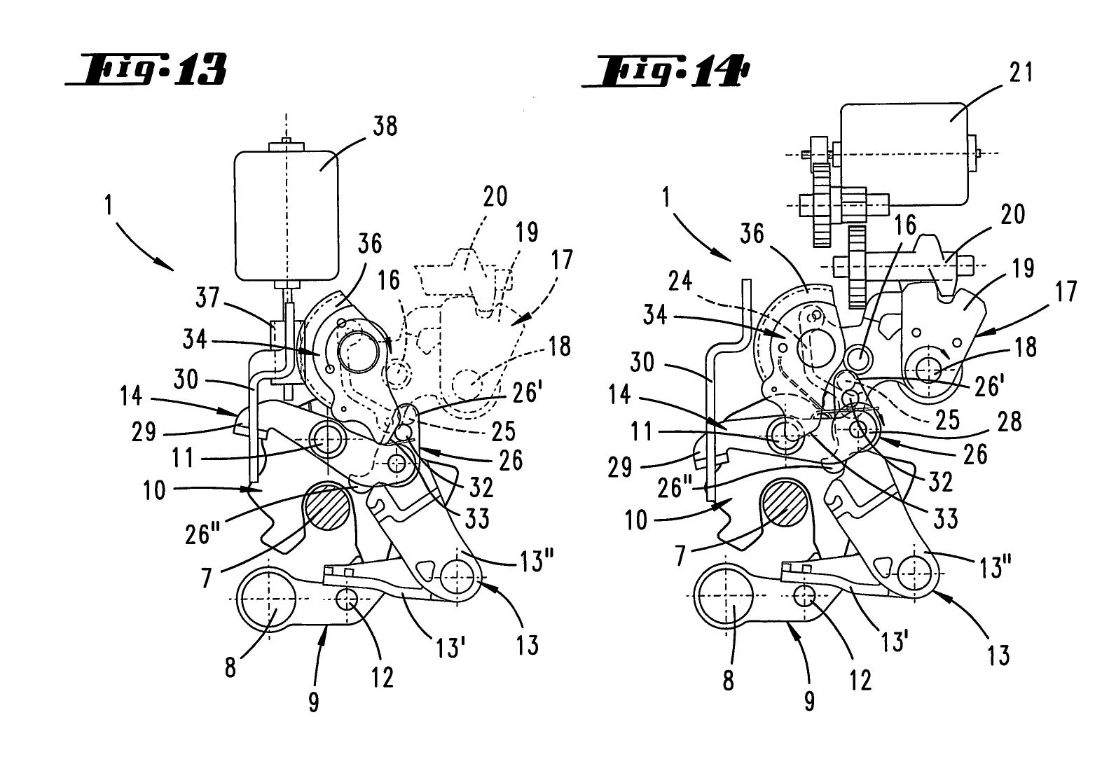

FIG. 1 shows a view of the lock with the door pulled shut and the mating locking part arrested by the rotary latch,

FIG. 2 shows a view of FIG. 1 rotated through 90°,

FIG. 3 shows an illustration solely of the lock components which interact with the exterior handle (not illustrated), the motor-vehicle door merely having been closed, that is to say pulled shut,

FIG. 4 shows an illustration corresponding to FIG. 3, but with the trigger displaced by the exterior handle and the lock opened via this trigger,

FIG. 5 shows an illustration which is comparable to FIG. 3, the safeguarding lever, which bearingly mounts the trigger, having been pivoted, by means of the first actuating motor, into the position which corresponds to the locked position,

FIG. 6 shows the follow-up illustration to FIG. 5, to be precise with the trigger pivoted by the exterior handle, the trigger being inactive and thus not causing the catch to be triggered,

FIG. 7 shows the follow-up illustration to FIG. 6, although, in contrast to the latter, the safeguarding lever has been pivoted, via the actuating motor, into the position which corresponds to the unlocked position, with the catch being triggered and the rotary latch being released in the process,

FIG. 8 shows an illustration solely of the lock components which interact with the interior handle, the motor-vehicle door having been closed and the interior handle not having been actuated,

FIG. 9 shows the side view, rotated through 90°, corresponding to FIG. 8,

FIG. 10 shows an illustration like FIG. 8, but with the interior handle actuated and the lock open,

FIG. 11 shows the side view, rotated through 90°, of FIG. 10,

FIG. 12 shows an illustration which is comparable to FIG. 8, although, in relation to the latter, the switching member has been moved, via the control member, into the inoperative position, the safeguarding position of the lock being realized in the process,

FIG. 13 shows an illustration which is comparable to FIG. 12, to be precise with the interior handle displaced and the inactive transmission lever pivoted in the process,

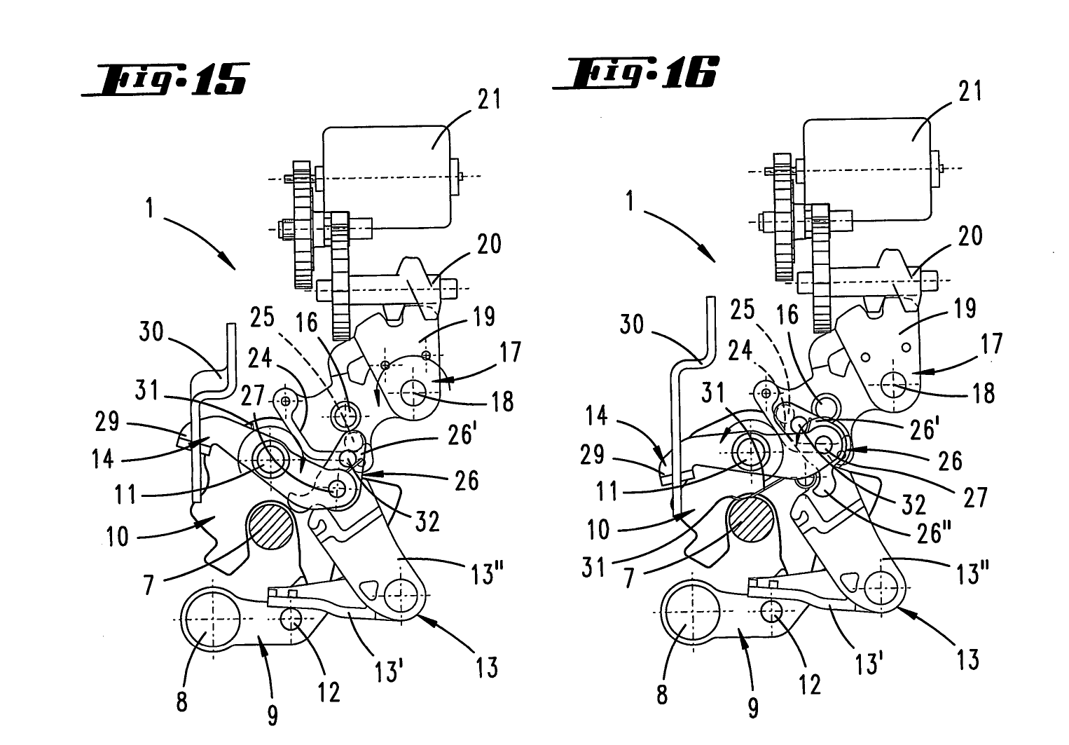

FIG. 14 shows an illustration like FIG. 12, but with the control member disengaged,

FIG. 15 shows the follow-up illustration to FIG. 14, to be precise with the interior handle actuated and the transmission lever displaced, the latter pivoting the safeguarding lever, during the first displacement, into the position which corresponds to the unlocked position,

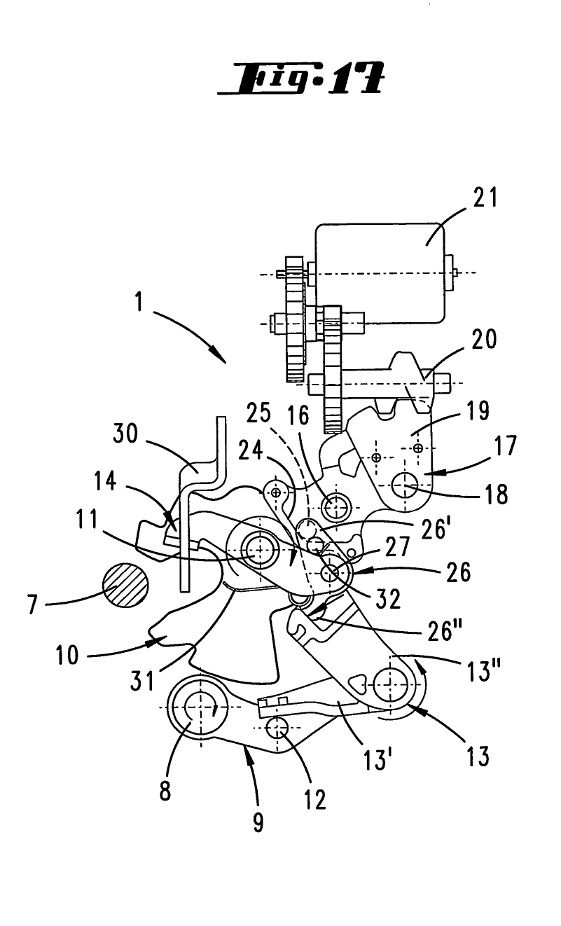

FIG. 16 shows the follow-up illustration to FIG. 15, to be precise once return displacement has taken place and the switching member has been restored, and

FIG. 17 shows the follow-up illustration to FIG. 16 following the second actuation of the interior handle.

The motor-vehicle door lock, which is designated overall by the numeral 1, has a cross-sectionally U-shaped housing 2. Housing side walls 4, 5 are angled from the housing base plate 3. An introduction opening 6 for a mating locking part 7 on the door frame opens out into the housing side wall 4. This means that the housing 2 is secured at a suitable location of a motor-vehicle door (not illustrated).

Beneath the introduction opening 6, the housing base plate 3 carries a catch spindle 8, about which a catch 9 is arranged in a pivotable manner. This catch is forced in the direction of a rotary latch 10 by a catch spring (not illustrated). The rotary latch is mounted about a base-plate spindle 11. A spring (not illustrated) forces the rotary latch 10 in the opening direction, that is to say, according to the exemplary embodiment illustrated, in the clockwise direction. In the position in which the mating locking part 7 is arrested, the catch 9 ensures that the rotary latch rotates back into the open position.

The catch 9, which is of single-armed configuration, carries a drive pin 12, which interacts with one lever arm 13′ of a V-shaped lever 13. The other lever arm 13″ of the latter, for its part, interacts with a transmission lever 14 and with a trigger 15. The trigger 15 is articulated in a rotatable manner on a pin 16 of a safeguarding lever 17. The latter is mounted, for its part, about a pin 18 of the base plate 3. The safeguarding lever 17 is the carrier of a worm-wheel segment 19, which interacts with a driving worm 20. The latter can be driven, via gearwheels, by means of a first actuating motor 21. This is an actuating motor 21, the direction of rotation of which can be switched over. FIGS. 1 and 3 illustrate that position of the safeguarding lever 17 which corresponds to the unlocked position of the lock. The trigger 15, which is configured approximately in the form of an arc of a semicircle, forms a pressure plate 15′ on the outside of the housing, the exterior handle of the door (this handle not being illustrated) acting on the pressure plate. On the inside of the housing, the trigger 15 carries a pin-like drive protrusion 22 for interaction with the free end of the lever arm 13″ of the V-shaped lever 13.

Also mounted about the pin 18 is an actuating lever 23, which has a clearance on one side in relation to the safeguarding lever 17 and, in a manner which is not illustrated more specifically, is coupled to a lock cylinder (not shown).

Adjacent to the point of articulation for the trigger 15, this point of articulation being formed by the pin 16, the safeguarding lever 17 forms a control rib 24 which runs at an obtuse angle and is intended for interacting with a control cam 25 of a switching member 26. This switching member is configured as a lever, and in particular an angled lever and is mounted about a pin 27 at one end 28 of the double-armed transmission lever 14. The latter is mounted in a rotatable manner about the rotary-latch spindle 11. The interior handle 30 acts at the other end 29.

The control cam 25 is located on the first arm 26′ of the switching member 26. The second arm forms a control protrusion 26″ for interacting with the lever 13 or the lever arm 13″ thereof. The switching member 26 is forced in the counterclockwise direction by a torsion spring 31, so that the control cam 25 is biased to support itself on the control rib 24. Opposite the control cam 25, the first arm 26′ carries a drive protrusion 32 for interacting with a control curve 33 of a control member 34. The latter is mounted, above the rotary-latch spindle 11, about an articulation pin 35 of the housing base plate 3. A worm-wheel segment 36 is connected in a rotationally fixed manner to the control member 34. This segment meshes with a worm 37 which, for its part, can be driven by a second actuating motor 38. The latter is also a drive, the direction of rotation of which can be switched over, and which interacts with the non-blocking worm drive 36, 37.

Functioning is as follows:

As far as the exterior actuation is concerned, you are referred, in particular, to FIGS. 2-7. FIGS. 1 to 3 illustrate the position of the lock 1 with the door having been closed by being pulled shut. The exterior handle is unlocked and unactuated. It can be further gathered from FIG. 3 that the safeguarding lever 17 has been pivoted, by the first actuating motor 21, into a position which corresponds to the unlocked position. On account of this position, the pin 16 assumes a corresponding position. Furthermore, the lever arm 13″ of the lever 13, which acts on the catch 9, extends in the pivoting path of the drive protrusion 22 of the trigger 15. From this unlocked position of the lock 1, the door can be opened. The exterior handle (not illustrated) can be actuated for this purpose. It acts on the trigger 15 in the arrow direction according to FIG. 4. This trigger pivots about its pin 16 of the safeguarding lever 17. The drive protrusion 22 here acts on the lever 13 in accordance with the arrow direction in FIG. 4, the lever, for its part, striking against the drive pin 12 of the catch 9 and triggering the latter. The rotary latch 10 is thus released for pivoting in the opening direction, so that the mating locking part 7 is disengaged from the rotary latch 10.

If the door is closed and, for example via radio control incorporated in the key, the locked position of the lock is desired, then the first actuating motor 21 transfers the safeguarding lever 17, by means of the worm drive 19/20, into the position which corresponds to the locked position. This means that it pivots in accordance with the arrow direction in FIG. 5. This is accompanied by displacement of the point of rotation 16 for the trigger 15, see FIG. 5. If the trigger 15 is then forced in the arrow direction by means of the exterior handle, the position according to FIG. 6 is established. It can be gathered from this that the drive protrusion 22 runs along on the free end of the lever arm 13″ of the lever 13 without triggering the catch 9. This means that the trigger 15 is inactive. The motor-vehicle door thus cannot be opened.

In order to open the motor-vehicle door, the unlocked position of the safeguarding lever 17 has to be brought about. If, however, prior to the unlocked position of the safeguarding lever 17 being reached, the trigger 15, as is illustrated in FIG. 7, is already actuated and the safeguarding lever 17 is pivoted, with a time delay, into the unlocked position via the first actuating motor 21, then the pin 16 of the trigger 15 changes its position. This is accompanied by the drive protrusion 22 acting on the lever 13 which, for its part, triggers the catch 9 and thus allows the opening rotation of the rotary latch 10, see FIG. 7.

The actuation of the lock from the inside of the door is explained with reference to FIGS. 8-17. FIG. 8 shows the relevant lock components interacting with the interior handle of the door. According to FIGS. 8 and 9, the motor-vehicle door is closed and in the unlocked position. The interior handle 30 has not been actuated. In this position, the transmission lever 14 runs approximately horizontally. The switching member 26, which is articulated at one end 28 thereof, is supported on the control rib 24 of the safeguarding lever 17 by way of its control cam 25. The control protrusion 26″, which is formed by the second arm 26″, extends from one shoulder of the lever 13 or of the arm 13″ thereof. This means that the switching member 26 is located in its operative position, which allows the lock 1 to be opened from the inside of the door by means of the interior handle 30, see FIGS. 10 and 11. The latter illustrate that the pivoted interior handle 30 has pivoted the transmission lever 14 in accordance with the arrow direction. The switching member 26 is carried along in the process, the switching member acting, by way of its control protrusion 26″, on the lever 13, at the arrow-designated point, and rotating this lever in the counterclockwise direction. This is accompanied by the catch 9 being triggered, so that the rotary latch 10 can be pivoted into its open position. The control member 34 is not activated.

FIG. 12 illustrates that, when the locked position of the lock is brought about, the second actuating motor 38 has pivoted the control member 34 in the arrow direction via the worm drive 36, 37. The control curve 33 of the control member 34 acts on the drive protrusion 32 of the switching member 26 and pivots the latter such that the control protrusion, which is formed by the second arm 26″, is disengaged from the lever 13. It is also the case that the control cam 25 passes out of operative connection with the safeguarding lever 17 or the control rib 24 thereof. The safeguarding lever 17 is located, according to FIG. 12, in the position which corresponds to the locked position, while the switching member 26 assumes its inoperative position, which corresponds to the safeguarding position of the lock. This means that the lock cannot be opened by the exterior handle of the door since the trigger 15 is inactive. It is also the case that actuation of the interior handle 30 results in the transmission lever 14 being inactive, since the switching-member control protrusion 26″ runs along on the lever 13 and does not pivot the latter, so that the catch 9 remains in engagement with the rotary latch 10, see FIG. 13. During this movement, the drive protrusion 32 slides along the control curve 33. The control cam 25 is inactive and, accordingly, does not cause the safeguarding lever 17 to be displaced.

Opening of the vehicle door once the side window of the vehicle door has been smashed in is thus ruled out in this safeguarding position.

It may be the case, however, that, when the vehicle is left, one or more people still remain in the vehicle. In order for it nevertheless to be possible for the motor-vehicle door to be opened from the inside, the control member 34 can be displaced back by virtue of the second actuating motor 38 being energized by key-based radio actuation. The switching member 26 is thus released in order to be pivoted back partially. This movement is limited by the control cam 25 being supported on the control rib 24. This supporting position, furthermore, corresponds to the inoperative position of the switching member 26. Opening of the door from the outside by actuation of the exterior handle is not possible since, on account of the adjusted safeguarding lever 17, the trigger 15 is inactive. Upon initial actuation of the interior handle 30, the safeguarding lever 17 is transferred, via the control cam 25 and control rib 24, from the position according to FIG. 14 into that according to FIG. 15. This is possible, for example, in that, in the locked position, the driving worm 20 assumes such an angle-of-rotation position that a radial slot located in the worm helix allows the safeguarding lever 17 to be pivoted from the position of FIG. 14 into that according to FIG. 15. Following the return displacement of the interior handle 30, the lock thus assumes the unlocked position, as is illustrated in FIG. 16. This allows the door to be opened from the outside as well. Upon opening from the inside of the door, in contrast, it is necessary to actuate the second actuation of the interior handle 30, which pivots the lever 13 via the transmission lever 14 and switching member 26, the lever 13, for its part, disengaging the catch 9, see FIG. 17.

The configuration according to the invention allows a modular construction of a lock. It is possible, for example, to dispense with the second actuating motor 38 along with the associated worm drive. This then does away with the double locking action. Only the locked position is achieved. It is then always possible for the motor-vehicle door to be opened by the interior handle. The second, completion stage is selected if the safeguarding position is desired, so that the abovedescribed configuration is present.

It is also possible to configure the lock such that it allows a childproof-locking position. Starting from the locked position, the lock can indeed be displaced into the unlocked position by initial actuation of the interior handle, but a second actuation of the interior handle is inactive. This can be achieved in that, in the childproof-locking position, the second arm 26″ is moved past the lever 8 without pivoting the latter. The catch 9 then thus remains in engagement with the rotary latch 10.

It should also be mentioned that the safeguarding lever 17 is forced by torques in the direction of the respective end position upon trigger actuation. Accordingly, the safeguarding lever remains, as intended, in its selected position.

In the unlocked position and also the safeguarding position, it is always possible to bring about the unlocked position, via the actuating lever 23, by means of the lock cylinder, this being accompanied by the safeguarding lever 17 being pivoted out of its position which corresponds to the locked position, so that the unlocked position then prevails. In the case of this lock-cylinder-induced unlocking, it is also possible, as a result of the non-blocking worm drive 36, 37, for the control member 34 to be displaced.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1-9. (canceled)

10. Motor-vehicle door lock (1) which can be actuated by means of an interior handle and an exterior handle, wherein the exterior handle acts on a trigger (15), actuation of which triggers a catch (9), which retains a rotary latch (10), in an unlocked position of the lock and is inactive in a locked position and in a safeguarding position;
wherein the interior handle (30) acts on a transmission lever (14), actuation of which triggers the catch (9) in the unlocked position and the locked position, and is inactive in the safeguarding position;
wherein the transmission lever (14) has a switching member (26) which, in the unlocked position, assumes an operative position, which allows transmission of movement to the catch (9), and, in the locked position, and in the safeguarding position, assumes an inoperative position, which renders the transmission lever (14) inactive; and
wherein in the locked position, initial actuation of the interior handle (30) switches over the switching member (26) from the inoperative position into the operative position, and switches over the lock (1) into the unlocked position.

11. Motor-vehicle door lock according to claim 10, wherein the trigger (15) is articulated in a rotatable manner on a safeguarding lever (17) which can be pivoted, by means of a first actuating motor (21), between a position which is associated with the unlocked position of the lock and a position which is associated with the locked position of the lock.

12. Motor-vehicle door lock according to claim 10, wherein the switching member (26) is formed as a lever, in particular an angled lever, which is disposed at the end (28) of the transmission lever (14) having two arms, has a control member (34), driven by a second actuating motor (38), acting on one arm (26′) and has its second arm (26″) acting, in particular via a lever (13), on the catch (9).

13. Motor-vehicle door lock according to claim 12, wherein a control protrusion formed by the second arm (26″), in the operative position, acts on the lever (13) upon actuation of the interior handle, and a control cam (25), which is formed by the first arm (26′) of the switching member (26), with the control member (34) disengaged in the inoperative position, acts on the safeguarding lever (17) upon initial actuation of the interior handle (30) in order to pivot the safeguarding lever into the position which is associated with the unlocked position and, with the control member (34) held in engagement, in order to move the control cam (25) past the safeguarding lever (17) upon actuation of the interior handle.

14. Motor-vehicle door lock according to claim 13, wherein the control cam (25) butts against a control rib (24) of the safeguarding lever (17) in the pivoted-back position of the control member (34), which is formed as a lever, and, with the control member (34) pivoted forward, a drive protrusion (32) of the switching member (26) slides along a control curve (33) of the same.

15. Motor-vehicle door lock according to claim 12, wherein the second actuating motor (38) acts on the control member (34) by way of a non-blocking worm drive (36/37).

16. Motor-vehicle door lock according to claim 10, wherein the lock has a childproof-locking position, in which, starting from the locked position, the lock can be displaced into the unlocked position by initial actuation of the interior handle (30), but second actuation of the interior handle (30) is inactive.

17. Motor-vehicle door lock according to claim 12, wherein the lock has a childproof-locking position, in which position the second arm (26″) of the switching member (26) is moved past the lever (13) and/or the catch (9) upon actuation of the interior handle.

18. Motor-vehicle door lock according to claim 11, wherein the first actuating motor (21) acts on the safeguarding lever (17) by way of a worm drive (19/20) which, in its two end positions, allows the safeguarding lever (17) to be pivoted freely, the safeguarding lever being forced by torques in the direction of the respective end position upon trigger actuation.
